(19) United States
(12) Patent Application Publication
(10) Pub. No.: US 2023/0194124 A1
(43) Pub. Date: Jun. 22, 2023

(54) HEATING DEVICE, HEATING SYSTEM, HEAT STORAGE DEVICE AND HEAT STORAGE SYSTEM

(71) Applicant: KRAFTANLAGEN MÜNCHEN GMBH, München (DE)

(72) Inventors: Till Doerbeck, München (DE); Jakob Herrmann, München (DE); Gerhard Schwarz, München (DE)

(21) Appl. No.: 17/923,349

(22) PCT Filed: Apr. 29, 2021
(86) PCT No.: PCT/EP2021/061303

§ 371 Date: Nov. 4, 2022

(30) Foreign Application Priority Data
May 4, 2020 (DE) 10 2020 111 987.9

(51) Int. Cl. F24H 3/04; F24H 7/04; F28D 20/00; F28D 17/02; F28D 17/04

(52) U.S. Cl. CPC F24H 3/0405; F24H 7/0416; F28D 20/0056; F28D 17/02; F28D 17/04

(57) ABSTRACT

A heating device for heating a gas stream is proposed, the heating device comprising two electric connection elements (43, 44) for being connected to a power source and at least one heating plate unit (39A, 39B, 39C, 39D, 39E) having an inlet side and an outlet side, which comprises a plurality of heating plate strips (45, 46) which are in the gas stream and each have a first end area and a second end area, adjacent heating plate strips (45, 46) being connected to each other in the first end areas and the second end areas each via a conductive spacer structure (47).

The invention relates to a heating device for heating a gas stream, to a heating system for a gas stream, to a heat storage device and to a heat storage system having a heat storage device of this kind.

In practice, heat storage devices are used for storing thermal energy, which can be made available to a power plant, if required, for example. A known heat storage device comprises a storage space in which a heat storage medium is disposed in the form of a filling or even in the form of molded bricks, hot air flowing through the heat storage medium for loading. The hot air has previously been heated to the required temperature by means of an electrically operated heating device, for example. To this end, excess electric energy can be used. The efficiency of such a heating device does not fulfill highest requirements, however. For unloading, i.e., dissipating the heat, hot air or ambient air flows through the heat storage device, this air being heated in the heat storage device and supplied in heated form to a consumer, for example a boiler of a turbine.

The object of the invention is to create the following: a heating device for heating a gas stream which has a high heat performance; a heating system for a gas stream which can be favorably used in a heat storage device; a heat storage device having an effective hot-air flow; and a heat storage system having a heat storage device of this kind.

According to the invention, this object is attained by the heating device having the features of claim 1; the heating system having the features of claim 10; the heat storage device having the features of claim 30; and the heat storage system having the features of claim 44.

According to the invention, a heating device for heating a gas stream is proposed, the heating device comprising two electric connection elements for being connected to a power source and at least one heating plate unit having an inlet side and an outlet side, which comprises a plurality of heating plate strips which are placed in the gas stream and each have a first end area and a second end area, adjacent heating plate strips being connected to each other in the first end areas and the second end areas each via a conductive spacer structure.

The heating device according to the invention therefore comprises a plurality of heating plate strips which are adjacent or superjacent and are joined with each other at their end areas for creating the heating plate unit or a heating plate bundle, this taking place via the conductive spacer structure. The heating plate strips of the heating plate bundle are switched parallel in the electric sense.

In this case, the term “heating plate strip” is to be understood in all its facets and refers to oblong metal plates as well as to oblong conductive ceramic layers, which are connected to each other in their end areas via the conductive spacer structure.

The heating plate strips of a heating plate unit provide a large surface for transferring heat between the heating device and the gas stream. This results in a large total cross section which can be flowed in, a slight flow resistance being present and large flow speeds being possible simultaneously because of the parallel orientation of the heating plates with respect to the direction of the gas stream. Consequently, favorable, low material temperatures are yielded at the plate strips during operation while the heat performance is high at the same time.

In a specific embodiment of the heating device according to the invention, the heating plate strips of the heating plate unit alternate between being structured and flat. In particular, the structured heating plates have a scalloping as a structuring, and form a type of honeycomb structure in conjunction with the flat heating plate strips, the gas stream being able to flow through the honeycomb structure. It is also conceivable for the heating plate unit to only comprise scalloped or only flat heating plate strips.

Furthermore, it is advantageous for the inherent stability of the heating plate unit if the scalloped heating plate strips are supported on at least one adjacent flat heating plate strip by their wave peaks.

The heating plate strips can have a smooth or even finely structured surface.

In a specific embodiment, the spacer structure of the heating device according to the invention comprises what is known as lining plates, which are disposed between adjacent heating plate strips and are connected to each other. The lining plates serve for a parallel orientation of at least the flat heating plate strips to each other; they form distancing plates which keep the end areas of adjacent heating plate strips at a distance to each other.

In order for the end areas of the structured and in this case in particular scalloped heating plate strips to be oriented parallel to the end areas of the flat heating plate strips, the lining plates have a thickness which corresponds essentially to the amplitude of the scalloping. The connection between the heating plate strips and the lining plates can be produced according to conventional connection methods; e.g., the heating plate strips and the lining plates are welded, soldered and/or riveted to each other in each instance in the two end areas.

A preferred embodiment of a heating device according to the invention, which can provide a large flow cross section, comprises at least two heating plate units between which an electrically insulating partition preferably made of ceramic is disposed. Preferably, more than two, for example six, heating plate units are intended, which are switched in series meanderingly.

The two heating plate units are preferably switched in series, but can also be switched parallel. Furthermore, the two heating plate units are preferably connected to each other via a contacting plate, which in particular abuts against the interconnected heating plate units on the front face.

The contacting plate, which connects the two adjacent heating plate stacks to each other, is preferably welded or soldered to the heating plate stacks.

The heating plate units, which are disposed adjacently in the heating device, represent in particular identically constructed, essentially rectangular component groups, which are disposed meanderingly behind each other. The heating plate units can also be slightly bent in one direction in order to be able to accommodate heat expansions in a defined manner. The entire construction then has an at least approximately rectangular base surface, one side being curved slightly inward and one side being curved slightly outward.

The electrically insulating partition is made in particular of a ceramic, high-temperature-resistant material. For instance, it consists of a fiber-reinforced ceramic or a ceramic texture, it being formed as a plate or a perforated plate.

In a specific embodiment, the partition is made of a material which is produced of a cordierite-based ceramic.

The partition serves to ensure a meandering circuit path through the heating plate units switched in series.

The connection elements of the heating device according to the invention are preferably also each made of an electrically conductive plate or a sheet. In particular in this case, they can align with the contacting plate which connects two heating plate units to each other.

The heating device according to the invention can either be connected to a direct-current or to an alternating-current voltage source and can be operated in a low-voltage or medium-voltage range at 100 V to 10 kV alternating current or at 12 V to 1.5 kV direct current.

According to claim 10, the subject matter of the invention is a heating system for a gas stream, the heating system comprising an inlet side and an outlet side and a heating assembly, which comprises at least one heating unit which comprises a heating device having an inflow base surface, which is perpendicular to the gas stream, and at least one mounting element on which the heating device is disposed and which is permeable to the gas stream so that the gas stream can flow onto the inflow base surface of the heating device or the gas stream can flow from the heating device through the mounting element.

According to the invention, the heating system therefor comprises at least one heating unit, which comprises the heating device and the at least one mounting element on which the heating device is disposed. The heating device defines the flow cross section of the gas stream, which can be heated using the heating device, by means of its base surface. The mounting element serves as a support for the heating device.

In a preferred embodiment of the heating system according to the invention, the mounting element of the heating unit is made of an electrically insulating, heat-resistant and in particular ceramic material. The material forms a structure which permits the gas stream to pass through. For instance, the mounting element forming a support matrix is made of a ceramic molded brick having a honeycomb structure, of ceramic rods, of a plate, of a perforated plate or of a differently formed component having an open structure. In particular, a fiber-reinforced ceramic can be inserted for producing the mounting element. A combination of different materials is also conceivable for producing the mounting element.

In a specific embodiment of the heating system according to the invention, the mounting element is made of a honeycomb ceramic which is cordierite-based. The honeycombs preferably have a square or rectangular cross section in the flow direction.

Preferably, the mounting element has a rest surface for the heating device, which corresponds to the inflow base surface of the heating device.

In order to prevent bypass currents from occurring, the mounting element is provided with lateral walls in a specific embodiment, the lateral walls laterally delimiting the heating device and being realized to be gas-tight at least in the transverse direction.

In a purposeful embodiment of the heating system according to the invention, the lateral walls are made in one piece with the mounting element. It is also conceivable, however, that the lateral walls represent separate component elements which are inserted on a bottom plate of the mounting element.

In a heating system, which provides a large flow cross section, several heating units are advantageously disposed adjacent to each other within the heating assembly. The heating assembly consequently comprises several mounting elements and several heating devices, which are disposed adjacent to each other and are conveniently electrically connected to each other, e.g., in series or even parallel.

Furthermore, an advantageous embodiment of the heating system according to the invention has at least two layers of heating units which are stacked on top of each other. This forms a stack heater whose performance can be adapted to changing gas volume currents by a targeted switching on and off of individual heating devices in a specific embodiment and for which a large thermal heat performance can be realized even for a limited flow cross section of the heating system.

In particular with the heat assembly realized as a stack heater, very high air exit temperatures can be realized which can be up to 1,000° C. or even higher.

With superjacent heating units, the lateral walls, with which the mounting elements are provided, are simultaneously the spacer structure between the individual mounting elements.

The lateral walls, which can be made in one piece with the mounting element or as separate ceramic or differently realized component elements, create a defined chamber for the heating device, meaning that it is securely positioned even in a gas flow at high speeds. In the stack heater described above, the chamber for the heating device is delimited from the top by a following heating unit or rather its mounting element. The uppermost heating unit layer can be delimited by a cover which can be passed through and which forms the upper side of the heating assembly and is preferably also made of at least one molded brick. The molded brick can have a square or rectangular circumference or have a honeycomb structure whose honeycombs in particular have a square or even hexagonal channel cross section. It is also conceivable that the cover consists of ceramic rods, of ceramic plates, of perforated plates or of other, gas-permeable component elements which are in particular made of a fiber-reinforced ceramic.

In order to secure the individual layers of the heating assembly or of the support matrix formed by the mounting elements against unwanted relative displacements, it is advantageous if the contact surfaces between the mounting elements are each provided with a mounting safeguard which is formed by a protrusion, for example, which engages into a recess of the adjacent mounting element. For instance, the protrusion is formed as a rib or knob, whereas the corresponding recess is formed as an indentation or groove.

The lateral walls, with which the mounting element is equipped, are preferably also formed so as to be gas-tight in the flow direction in order to prevent bypass currents beside the inflow base surface of the heating device. For instance, the lateral walls are sealed by means of a ceramic paper or the like for this purpose.

In another specific embodiment, the heating system according to the invention comprises a ceramic and/or metal carrier structure, on which the heating assembly is disposed. For instance, the carrier structure comprises a grid on which the heating assembly rests. It is also conceivable that the carrier structure comprises at least one molded brick, at least one insulating fire brick and/or a ceramic or metal filling, preferably at least one honeycomb molded brick. In each instance, the carrier structure can be passed through by the gas stream.

In order to ensure an even gas stream across the free cross section of the heating assembly, the carrier structure can comprise static and/or settable throttle elements. A static throttle element is, for example, a perforated plate.

In order to shield the heating assembly from the environment, the heating system according to the invention preferably has a heating channel in which the heating assembly is disposed. For outward thermal insulation, the heating channel, which in particular can be formed by a tube or a rectangular flow channel, can have inner insulation.

In order to enable servicing the heating assembly, the reception channel can have a lateral opening, which is closed by means of a detachable lid element.

Furthermore, it can be advantageous for regulating the gas stream if the heating system according to the invention has a throttle device and/or a blocking device on the inlet side and/or the outlet side. These are in particular formed by valves and/or shutters.

The heating device of the heating system according to the invention is preferably formed according to the heating device as described above.

Furthermore, the heating system according to the invention has a temperature measuring element on the outlet side, by means of which the gas exit temperature can be regulated. The temperature measuring element is preferably disposed at a minimal distance to the heating assembly in an electrically insulated manner, meaning the temperature of the gas stream can be measured after exiting the heating assembly at a minimal temporal offset.

In a preferred embodiment, the temperature measuring element is a thermal element or rather a PT100 having a jacket tube, its measuring tip being disposed in the center of a circular, hexagonal, square or rectangular measuring channel of the cover of the heating system disposed in the flow direction so that the temperature of the gas stream can be determined without any relevant dead time. For instance, the temperature measuring element is disposed in a horizontal bore of the cover. Additionally or alternatively, a temperature measuring element can be disposed in the bottom plate of the mounting element.

The temperature of the gas stream on the outlet side can be regulated in different manners. At a constant electric heat performance, however, the gas stream through the heating assembly is preferably throttled or increased according to the deviation measured on the outlet side between a target and an actual temperature by means of a throttling element at the channel inlet and/or at the channel outlet and/or is adjusted by changing the fan rotational speed. The type of regulation is suitable in particular for a stationary operation at a constant heat performance.

In non-stationary operating states, for example in heating processes or changing entry temperatures of the gas stream flowing into the heating system, the gas exit temperature can be regulated by adapting the electric heat performance by means of, for example, a thyristor control or by switching on or off individual heating units or heating unit groups.

Furthermore, the heating system can comprise several heating assemblies of the type described above of which each is realized as a stack heater. These can be disposed adjacent to each other, behind each other and/or on top of each other. Power can be supplied using multiphase current so that the individual heating assemblies are controlled in a targeted manner and able to be switched on as required.

A heat storage device is also the subject matter of the invention. This heat storage device comprises a container having an interior which has a storage space in which a heat storage means for storing thermal energy is disposed, the container comprising a first opening via which a gas stream can be conducted into the interior and a second opening via which the gas stream can be dissipated. Furthermore, the heat storage device comprises a heating space in which a heating system is disposed through which the gas stream can flow, the heating space being connected to the storage space for the heat storage means via an open volume of the interior. Both the heating space and the storage space are placed in the container.

In the heat storage device according to the invention, the heating system, by means of which the gas stream can be heated, and the heat storage means, by means of which its thermal energy can be stored, are consequently disposed in different areas of the interior of the container. Between the heating system and the heat storage means or rather via its two units, an open volume is formed, via which the gas stream, which has been heated by the heating system, can flow to the heat storage means. The open volume is a gas distribution chamber of the heat storage device which ensures that the gas heated by the heating system flows evenly through the entire cross section of the heat storage means and transfers the heat thereto.

The heat storage device according to the invention can be used in order to store excess electric energy from strongly fluctuating regenerative sources, such as wind power plants or photovoltaic systems or other connected power grids, efficiently in the form of heat at a high temperature level. Thus, the corresponding power grid can be stabilized. The heat stored in the heat storage means of the heat storage device can be converted to electric power at a later period in time if required via, for example, a water-steam process, an Organic Rankine Cycle (ORC) or the like or even be output to a different process (industrial heat supply, drying etc.). Additionally, the heat storage device can be used for continuously converting electric energy to heat at a high temperature level, for example for supplying the industry with heat, independently of the loading state of the heat storage means for a down-stream process.

Generally, the heat storage device according to the invention represents a storage for thermal energy which can dissipate the energy to a gas stream in the form of heat simultaneously or at a temporal offset compared to the converted electric energy.

As the heating system is disposed in the container without an additional casing or heat insulation, a minimization of the thermal inertia of the total system can be achieved.

Furthermore, the heating space, which is formed in particular as a heating channel and in which the electric heating system is disposed, forms a thermosiphon, which permits a thermally favorable placement of possibly required blocking and throttling elements at a position of the heat storage device, where low temperatures are present, and which barely generates thermal loss because of its placement in the container in comparison to an external thermosiphon.

In an advantageous embodiment of the heat storage device according to the invention, the heating space, in which the electric heating system is disposed, is separated from the reception space for the heat storage means by a partition. The heating space is thus disposed in a defined area of the interior of the container.

In order for the gas stream to efficiently flow through the heat storage means, the heat storage means is disposed on a carrier structure in a preferred embodiment of the heat storage device according to the invention. For instance, the carrier structure is a grid structure, which is fixed to the walls of the container or is mounted on a bottom of the container in the manner of a table.

In order to benefit the dissipation of the gas stream after loading the heat storage means, a distribution space, which is connected to a hot-air opening of the container, is disposed below the carrier construction. In particular the hot-air opening is the second opening of the container.

A particularly efficient loading and unloading process can be realized when the heat storage device according to the invention has an additional unloading opening which is disposed above the heat storage means. For instance, the heat storage is unloaded in such a manner that a warm gas stream and/or ambient air (in an open system) is introduced via a hot-air opening and guided through the heat storage means. There, the warm gas stream is heated and then dissipated from the heat storage device via the unloading opening as a hot-air stream.

In a specific embodiment of the heat storage device according to the invention, the heat storage means comprises molded bricks through which the gas stream can flow and which preferably form a wall composite. For instance, the molded bricks each have a honeycomb structure having vertically standing channels which each have a square or even hexagonal cross section.

In an alternative embodiment, it is also conceivable that the heat storage means comprises a filling or the like, which consists of a suitable material, in addition to the molded bricks or instead of the molded bricks.

In order to be able to exchange or service the heating system, the heat storage device according to the invention has a servicing opening, which is closed by means of a detachable wall element, in a preferred embodiment.

The servicing opening of the heat storage device preferably leads directly into the heating channel, in which the electric heating system is disposed.

The heating channel, in which the electric heating system is disposed, preferably has at least one mostly rectangular cross section. The electric heating system can be easily fit into this cross section.

A particularly efficient distribution of the gas stream across the cross section of the heat storage means can be achieved when the heating space, in which the electric heating system is disposed, has an exit opening, which is disposed at the same level as an upper side of the heat storage means, the open volume being placed above the heat storage means.

In a preferred embodiment of the heat storage device according to the invention, the electric heating system disposed in the heating space comprises a resistance heater and in particular a heating system which is formed having a mounting element and a heating unit according to the heating system described above. Consequently, the heating system can be realized in the manner of a stacked heater.

A heat storage system is also the subject matter of the invention, the heat storage system comprising a heat storage device of the type described above and a pipe assembly which is connected to the heat storage device. The pipe assembly can lead to a consumer to which the heat stored in the heat storage in the heat storage device can be supplied in the form of hot air via the pipe assembly. For instance, the consumer is a heat exchanger (for example a steam generator) of a power plant so that electricity can be produced by means of a turbine and a generator by means of the heat stored in the heat storage device.

In order to be able to guide the gas stream through the heat storage device, the heat storage system preferably has a fan which can preferably be set with regard to rotational speed and is disposed in the pipe assembly.

Furthermore, the pipe assembly preferably comprises a charging circuit, which is connected to two openings of the heat storage device, making it possible to introduce hot air via an opening. In the heat storage device, the hot air is heated in the heating system and subsequently unloaded in the heat storage means after flowing through the open volume of the interior in order to then be able to flow out of the heat storage device as hot air via the second opening.

Preferably, the pipe assembly comprises valves and shutters for controlling the gas stream through the heat storage device.

Further advantages and advantageous embodiments of the subject matter of the invention can be derived from the description, the drawing and the patent claims.

Exemplary embodiments of the subject of the invention are shown in the drawing in a schematically simplified manner and are described in further detail in the following description.

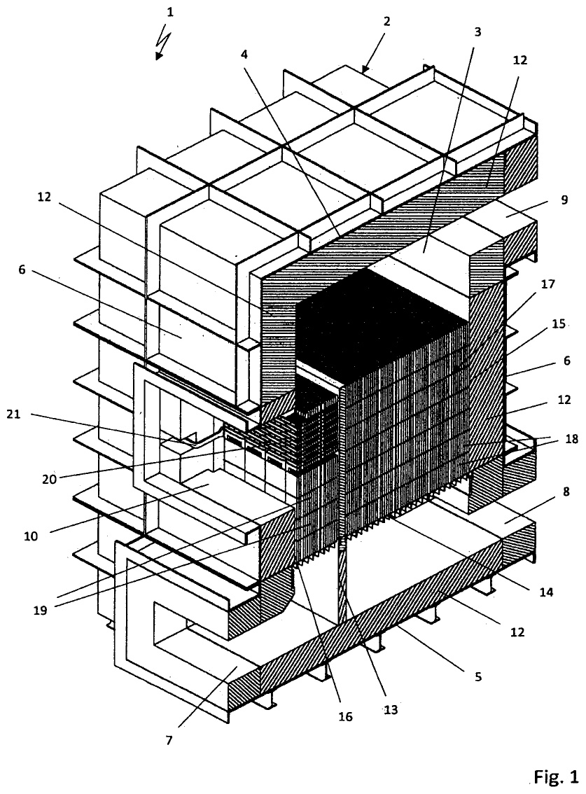

FIG. 1 shows a schematic, perspective cross-sectional view of a heat storage device;

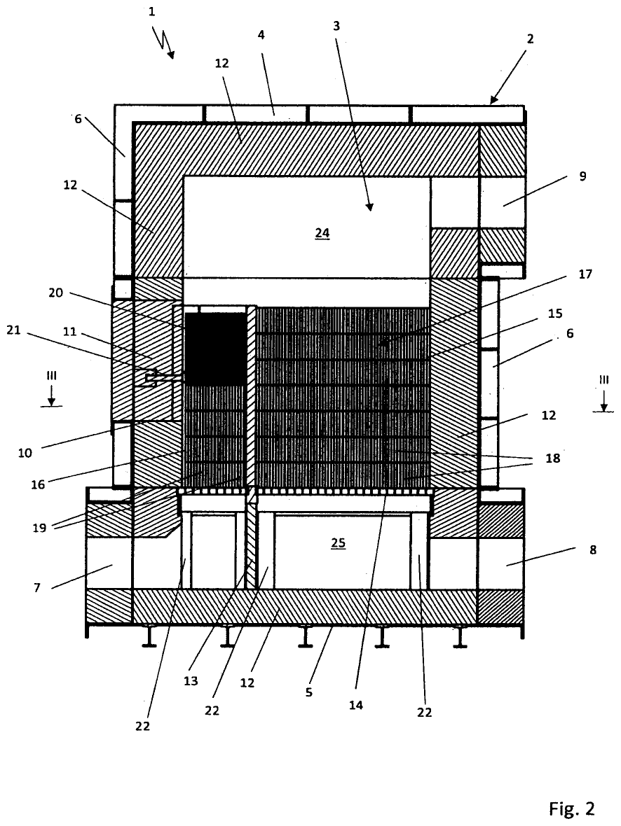

FIG. 2 shows a top view of the cross-sectional cut in FIG. 1;

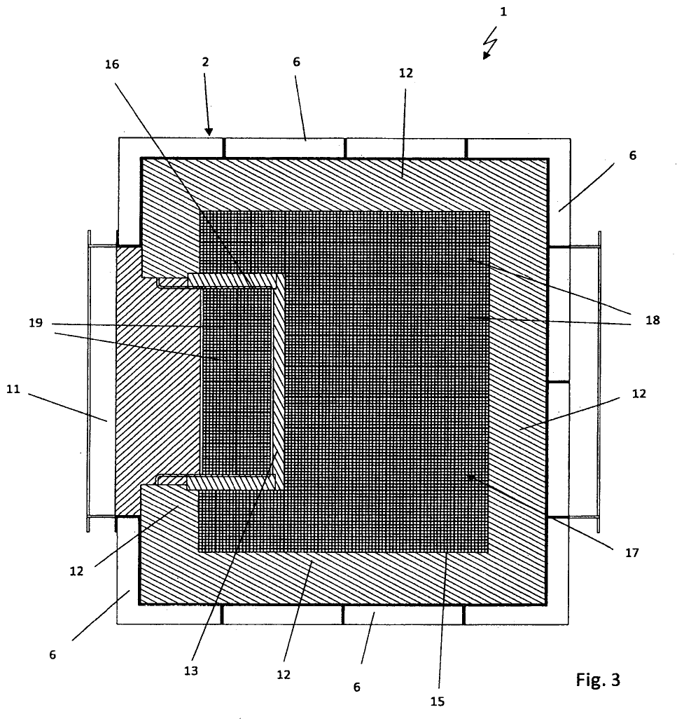

FIG. 3 shows a cross-sectional cut through the heat storage device along line III-III in FIG. 2;

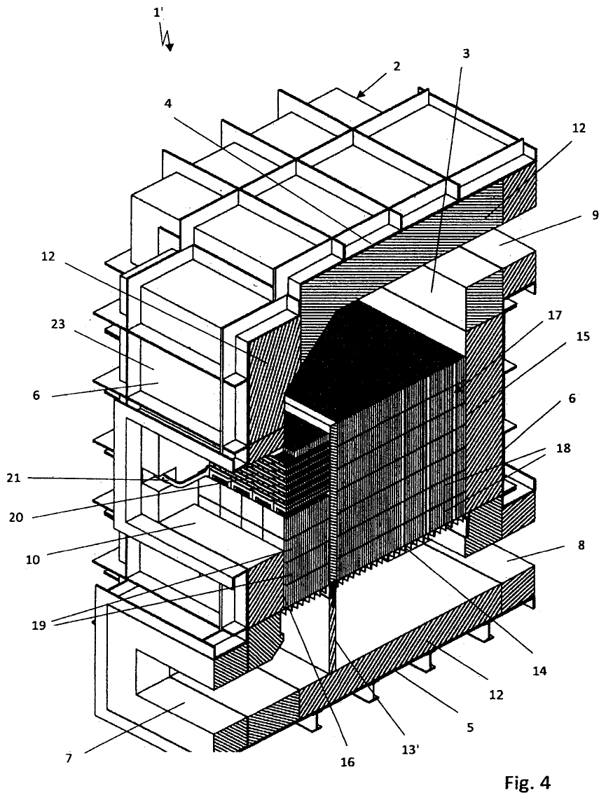

FIG. 4 shows a perspective cross-sectional cut through an alternative embodiment of a heat storage device;

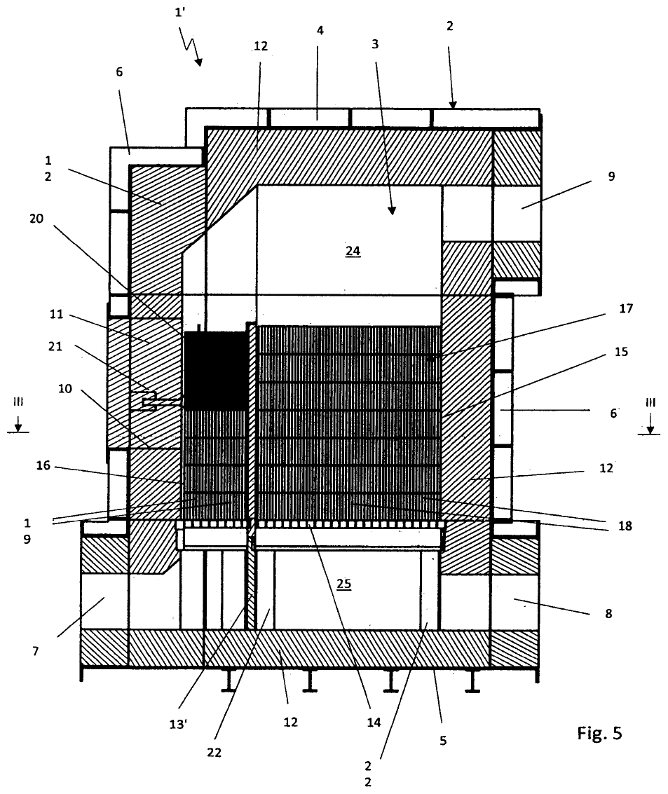

FIG. 5 shows a top view of the cross-sectional cut in FIG. 4;

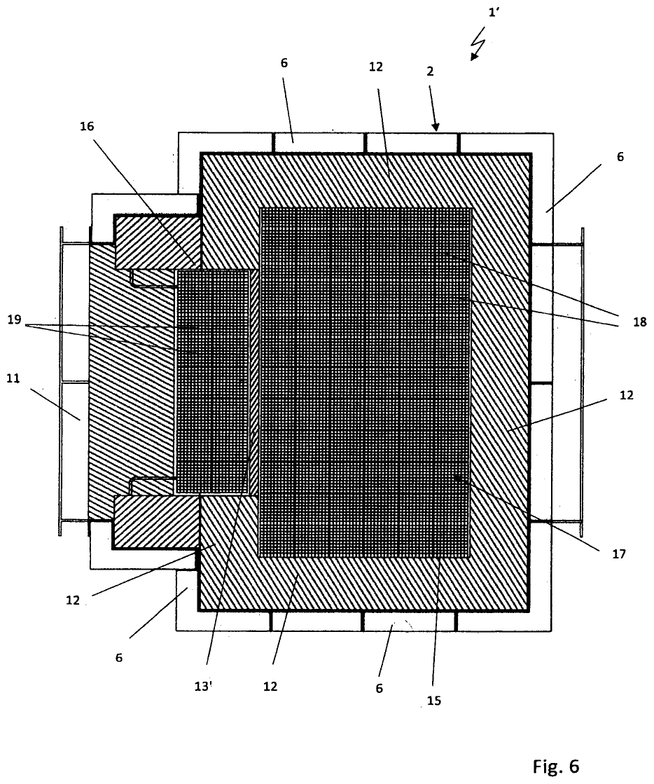

FIG. 6 shows a cross-sectional cut through the heat storage device according to FIG. 5 along line VI-VI in FIG. 5.

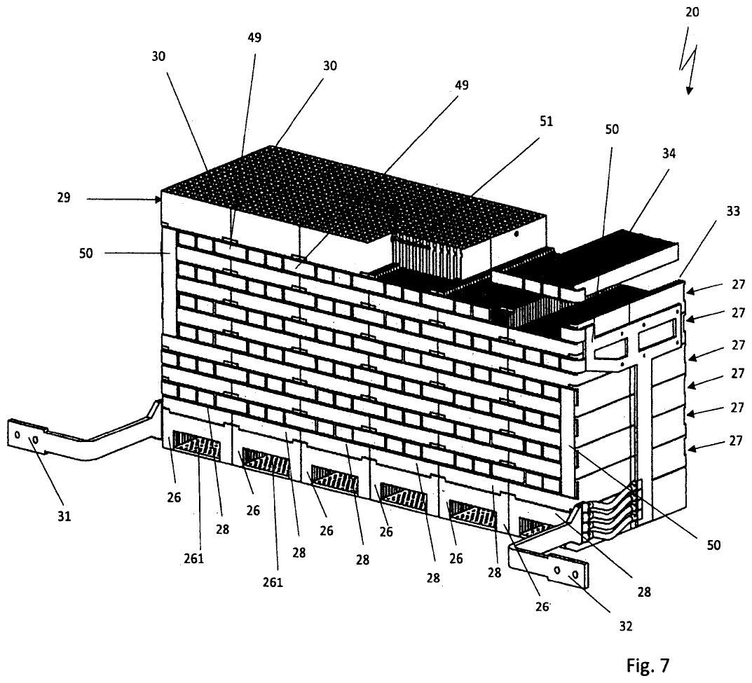

FIG. 7 shows a heating system of the heat storage device according to FIGS. 1 to 6;

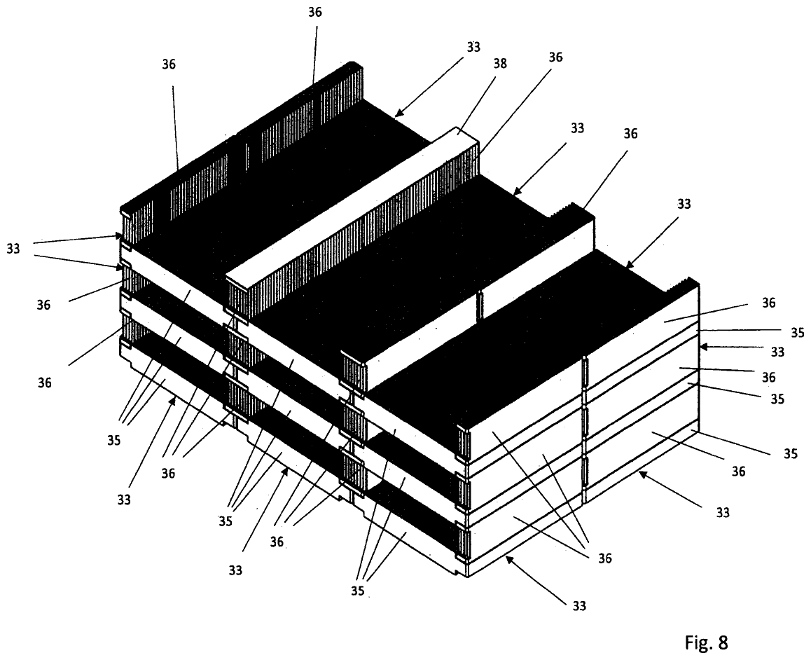

FIG. 8 shows a perspective view of a variation of a support matrix of the heating system;

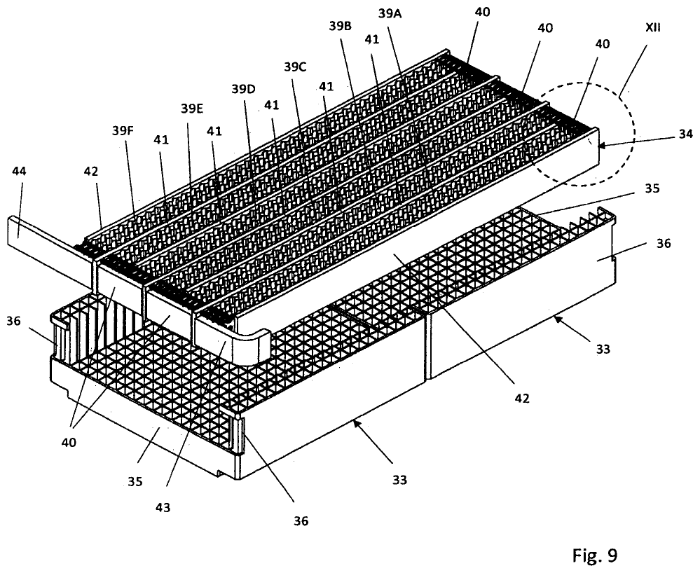

FIG. 9 shows a heating unit of the heating system according to FIG. 7;

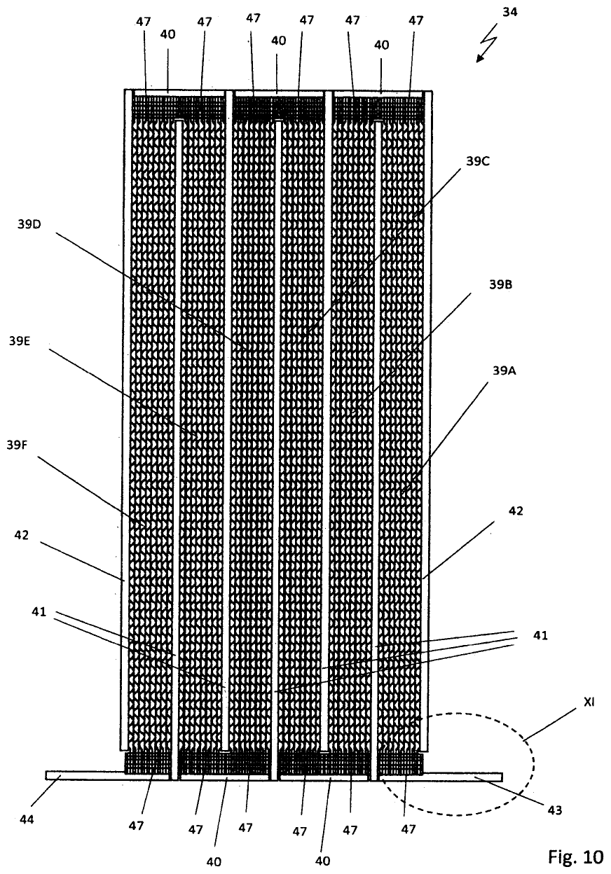

FIG. 10 shows a top view of a variation of a heating device of a heating unit of the type shown in FIG. 9;

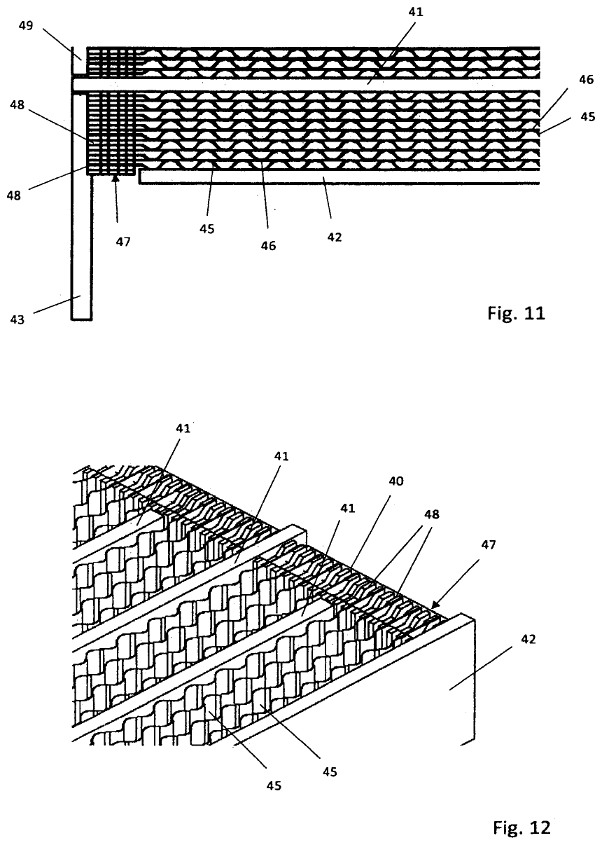

FIG. 11 shows an enlarged view of the area XI in FIG. 10;

FIG. 12 shows an enlarged view of the area XII in FIG. 9;

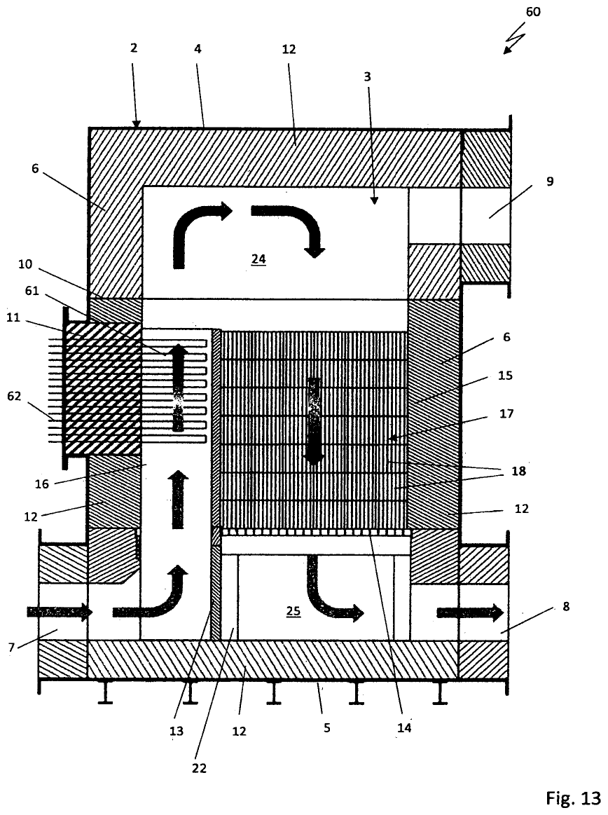

FIG. 13 shows a cross-sectional cut through an alternative embodiment of a heat storage device during a loading operation;

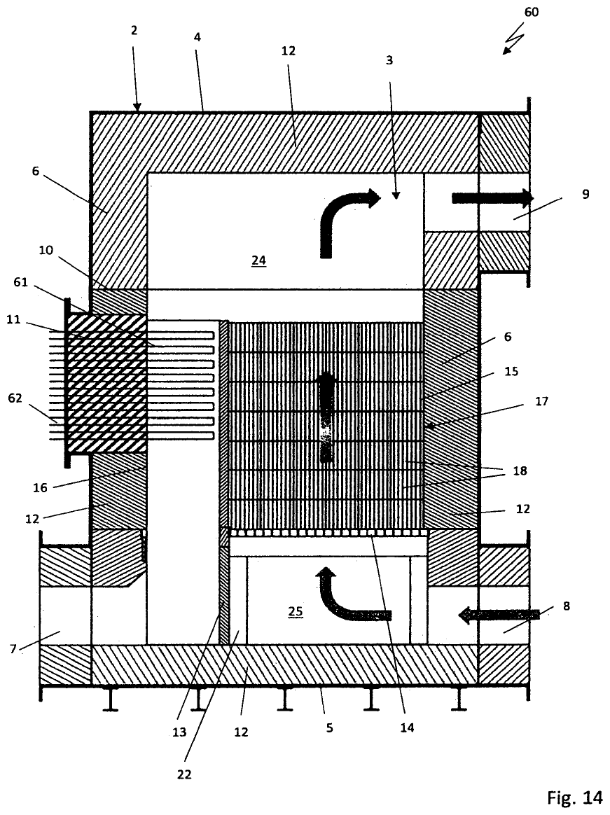

FIG. 14 shows an unloading operation of the heat storage device according to FIG. 13;

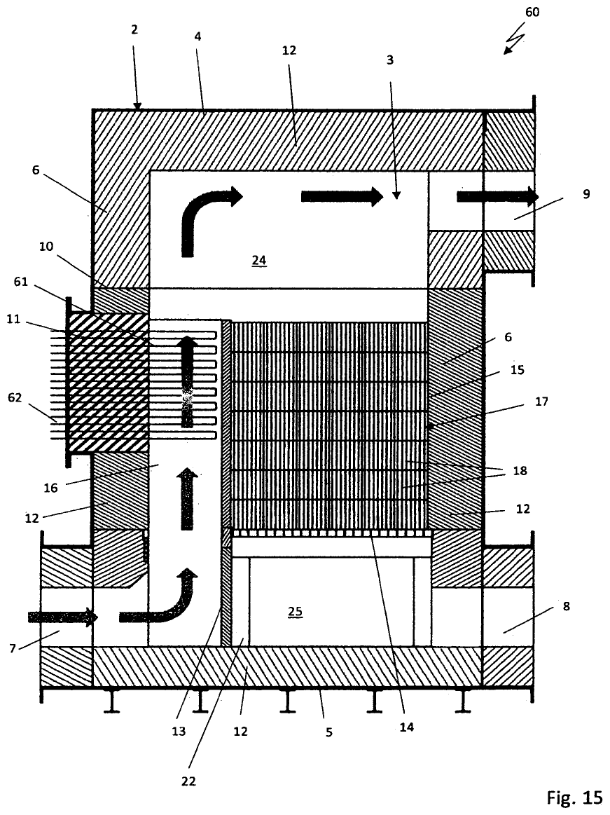

FIG. 15 shows a heating operation without a storage process of the heat storage device according to FIG. 13;

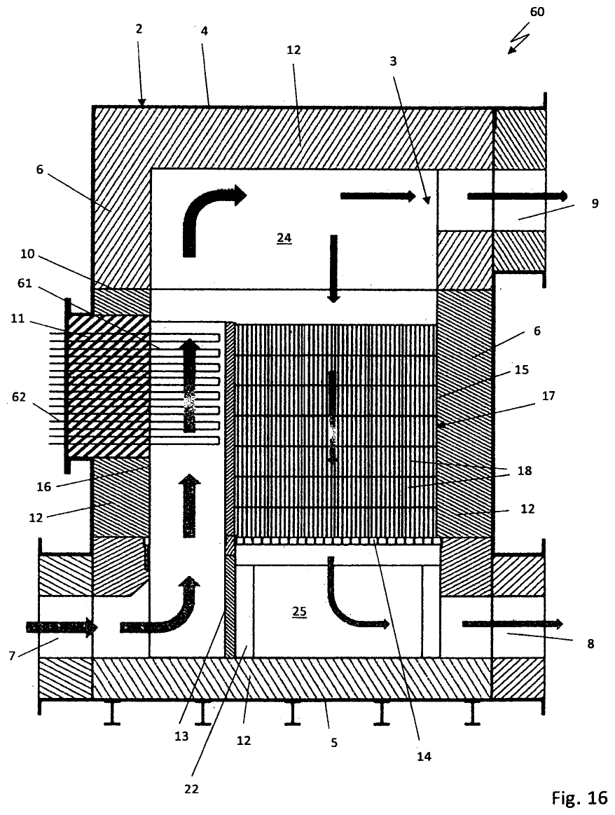

FIG. 16 shows a heating operation with a loading process of the heat storage device according to FIG. 13;

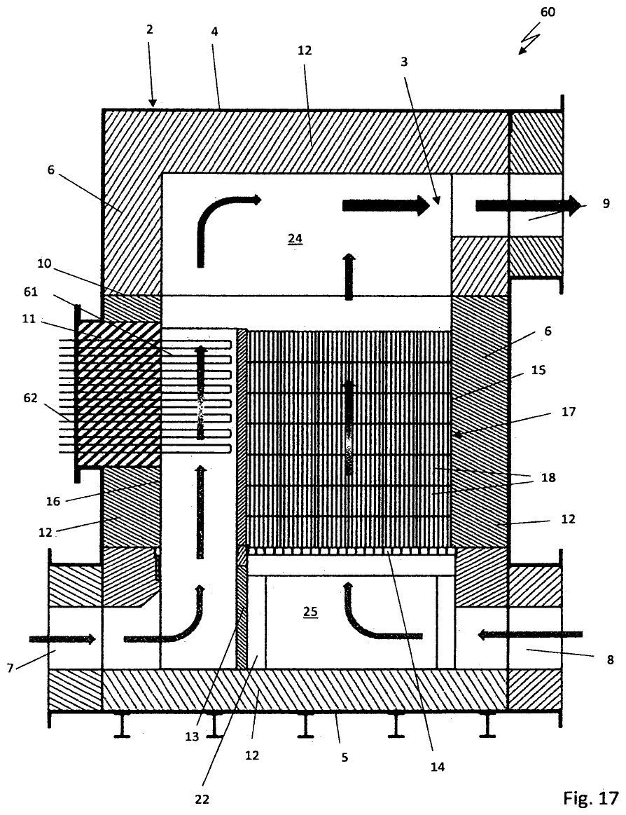

FIG. 17 shows a heating operation with a simultaneous unloading process of the heat storage device according to FIG. 13;

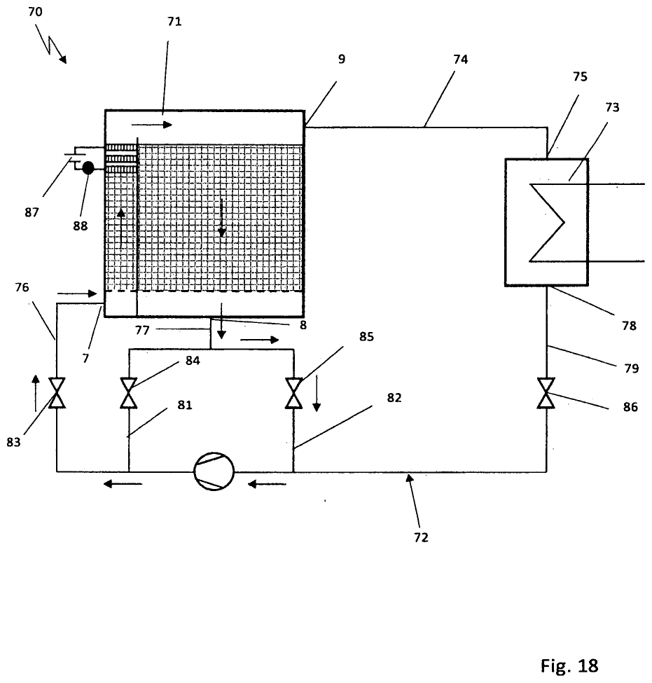

FIG. 18 shows a schematic concept of a heat storage system having a consumer in the loading mode;

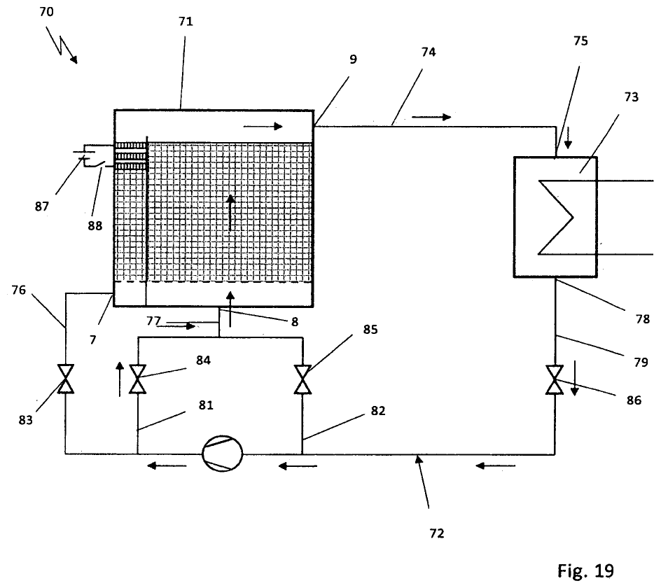

FIG. 19 shows the heat storage system according to FIG. 18 in an unloading mode; and

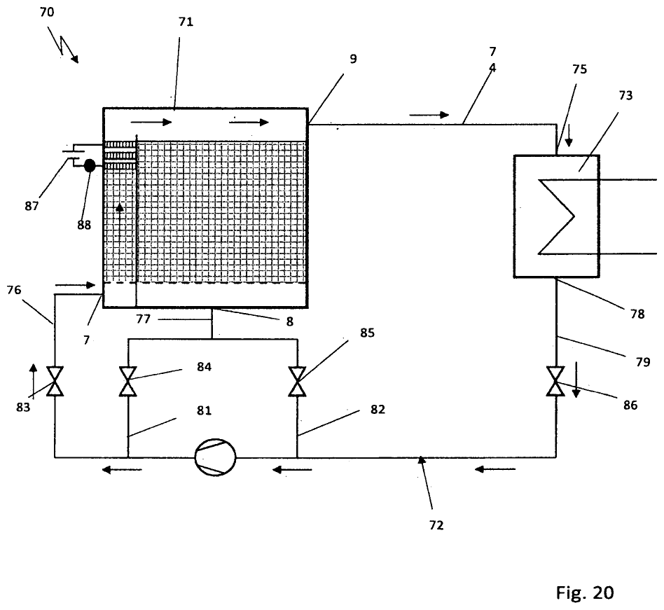

FIG. 20 shows the heat storage system according to FIG. 18 in a heating mode.

In FIGS. 1 to 3, a heat storage device 1 is shown which can be used to store excess electric energy from strongly fluctuating regenerative sources, such as from wind power plants or photovoltaic systems, or from connected power grids in the form of heat at a high temperature level and to thus stabilize the power grid. The stored heat can be converted to electric power at a later point in time via a water-steam process, an ORC process or the like as required or be dissipated indirectly in the form of steam or directly in the form of hot gas for other industrial or supply processes. Moreover, heat storage device 1 can generate hot air at a high temperature level by using electric energy, the hot air being able to be used in connected power-plant or industrial processes.

Heat storage device 1 comprises an in the broadest sense cuboidal container 2 in which an interior 3 is formed which extends in the vertical direction between a container lid 4 and a container bottom 5 and in the transverse directions between four lateral walls 6.

Container 2 is equipped with a loading opening 7 on a lateral wall 6 near container bottom 5; with an inlet/outlet opening 8 on another lateral wall 6 near container bottom 5; and with an unloading opening 9 on these lateral walls 6 adjacent to container lid 4. Loading opening 7, inlet/outlet opening 8 and unloading opening 9 are connectable to pipes of a tube system.

Furthermore, a servicing opening 10, which can be closed to be gas-tight by means of a detachable wall element 11, is formed on lateral wall 6, on which loading opening 7 is formed, in an area centered in the vertical direction.

On the inner side, lateral walls 6, container lid 4 and container bottom 5 are each provided with high-temperature resistant insulation layers 12.

Interior 3 of container 2 is essentially cuboidal in its dimensions. Moreover, a partition 13, which is essentially U-shaped in its cross section and is placed on container bottom 5 and has a vertical orientation, is formed in interior 3. Partition 13 abuts against lateral wall 6 with its short legs, servicing opening 10 being formed on lateral wall 6.

At a distance to container bottom 5 and above loading opening 7 and inlet/outlet opening 8, interior 3 is spanned by a grid structure 14 which has a horizontal orientation and is fastened to lateral walls 6 and partition 13 and/or stands on container bottom 5 on feet 22. Grid structure 14 forms a carrier structure or carrier construction.

Partition 13 separates a storage space 15 from a heating space 16 of interior 3. Storage space 15 receives a heat storage means 17 which consists of superjacent ceramic molded bricks, which each have a square layout and each have a honeycomb structure, whose honeycombs form flow channels which extend in the vertical direction and/or upward direction of heat storage device 1.

In an alternative embodiment, heat storage means 17 can also be made of a filling or the like.

Molded bricks 18 extend from grid structure 14 till nearly the upper edge of partition 13 and reach around partition 13 on its three sides, as can be seen in FIG. 3.

Heating space 16 forms a heating channel, which is delimited at the bottom by grid structure 14 and is disposed on a stack of molded bricks 19 acting as the carrier construction, molded bricks 19 each also having a honeycomb structure and corresponding to molded bricks 18 disposed in storage space 15. The stack of molded bricks 19 have a construction height which is shorter than that of molded bricks 18 in storage space 15. On molded bricks 19, a heating assembly 20 is disposed which represents an electric heating device and is connected to a power source, such as a wind power plant, a photovoltaic system and/or the power grid, via connections 21. An upper side of heating assembly 20 aligns approximately with the upper side of heat storage means 17 in storage space 15.

As described above, servicing opening 10 can be closed by means of a detachable wall element 11. Wall element 11 has an insulation plug on its inner side.

Storage space 15 and heating space 16 are connected to each other via an open volume 24 of interior 3, open volume 24 being disposed above heating space 16 provided with the heating system or above storage space 15 filled with heat storage means 17 and forming a gas distribution space.

Below heating space 16, i.e., below grid structure 14, a gas distribution space 24 is disposed via which gas can flow into heating space 16 from loading opening 7. Below storage space 15, in which heat storage means 17 is disposed, a gas distribution space 25 is disposed which is connected to inlet/outlet opening 8.

In FIGS. 4 to 6, a heat storage device 1′ is shown which represents an alternative embodiment and mostly corresponds to the heat storage device shown in FIGS. 1 to 3, but differs in the respect that container 2 comprises a lateral wall 6′, which has a ledge 23 at an outward offset, on the side of servicing opening 10. Thus, it is possible for a partition 13′, which separates a heating space 16 from a storage space 15 of interior 3, to align with the inner side of lateral wall 6′.

In all other respects, heat storage device 1′ corresponds to the heat storage device in FIGS. 1 to 3, for which reason reference is made to the description thereof

In FIG. 7, heating assembly 20 of the heating system disposed in heating space 16 of the heat storage devices described above is shown on its own. On its bottom, heating assembly 20 is provided with two consecutive rows of six molded bricks 26, which form a carrier structure and each have a honeycomb structure and whose channels formed by the honeycombs can be passed through in the vertical direction. Molded bricks 26 are ceramic molded bricks, which are cordierite-based. On molded bricks 26, which essentially have an inverted U-shaped cross section and are provided with a perforated plate 261 representing a static throttle element, several layers 27 are disposed which in this instance are each made of six adjacent heating units 28. On the top side, heating assembly 20 is delimited from adjacent molded bricks 30 by a layer forming a cover 29, molded bricks 30 also having a honeycomb structure and whose channels formed by the honeycombs being oriented in the vertical direction and being able to be passed through. Furthermore, heating assembly 20 comprises two connection contacts 31 and 32, which are connected to a power source or a power grid.

Heating units 28 are generally assembled from the same parts and each comprise two mounting elements 33 and a heating device 34. Mounting elements 33 are each made of a ceramic molded brick, which is cordierite-based and has a honeycomb structure. The individual honeycombs of mounting elements 33 each form a channel extending in the vertical direction and each have a square layout. Furthermore, mounting elements 33 each have an essentially U-shaped cross section, meaning a bottom plate 35 and two lateral walls 36 are formed which delimit a receiving space for a precisely fit reception of heating device 34. On the underside, bottom plates 35 of mounting elements 33 each have a recess 37 in the area of the lateral edges, recess 37 having a rectangular cross section and the upper side of corresponding lateral wall 36 of subjacent mounting element 33 engaging into recess 37 in the stacked state. Thus, a precise positioning of the superjacent mounting elements 33 is ensured. Upper ribs of molded bricks 26 engage in recesses 37 of the lower layer of heating unit 28.

In the variation shown in FIG. 9, lateral walls 36 and bottom plate 35 of a mounting element 33 are made in one piece. In the variation shown in FIG. 8, lateral walls 36 are separate components which are each inserted on a bottom plate. Moreover, adjacent mounting elements each share a lateral wall, i.e., this lateral wall reaches across adjacent bottom plates 35.

To prevent a passing through of lateral walls 36 and thus a bypass gas stream, lateral walls 36 are provided with a seal 38 on their upper side, seal 38 consisting of a ceramic paper, for example (cf. FIG. 8).

Heating device 34 of heating units 28 are essentially the same structurally and each have an inflow base surface which in this case corresponds to the surface between lateral walls 36 of two consecutive mounting elements 33. When installed, heating device 34 rests on bottom plates 35 of these two mounting elements 33. As in particular FIGS. 9 to 11 show, heating devices 34 each comprise six heating plate units 39A, 39B, 39C, 39D, 39E, and 39F, which are switched in series. For this purpose, heating plate units 39A and 39B, heating plate units 39B and 39C, heating plate units 39C and 39D, heating plate units 39D and 39E and heating plate units 39E and 39F are connected to each other in each instance via a contact sheet 40 which is disposed on a corresponding front face of heating device 34. Between adjacent heating plate units, a partition 41 is disposed in each instance, which is made of an electrically insulating material, for example a ceramic material, and ensures an electric insulation between each adjacent contact plate 40. Furthermore, heating device 34 comprises lateral walls 42 which touch against corresponding lateral walls 36 of the two corresponding mounting elements 33 or abuts against there. In order to establish electric contact, heating device 34 has a first connector 43 and a second connector 44, connectors 43 and 44 each being made of a plate part which aligns with contact plates 40, which is disposed on the corresponding front face of heating device 34. Connector 43 is electrically connected with a front face of heating plate 39A, whereas connector 44 is electrically connected to a front face of heating plate unit 39F.

Individual heating plate units 39A, 39B, 39C, 39D, 39E and 39F each comprise a plurality of heating plate strips 45 and 46.

In the embodiment shown in FIG. 11, scalloped heating plate strips 45 and flat heating plate strips 46 are disposed alternately in succession to each other in the stacking direction, the scalloped heating plate strips 45 being supported on adjacent flat heating plate strips 46 by their wave peaks. The outer scalloped heating plate strips 45 are also supported on corresponding partition 41 or on corresponding lateral wall 42.

In their end areas, heating plate strips 45 and 46 are parallel to each other and connected to each other via a spacer structure 47 each, which also establishes the contact of the corresponding heating plate stack on connector 43 and 44 and/or of corresponding contact plate 40. Spacer structure 47 comprises lining plates 48, which are realized as spacing elements, are disposed between the parallel end areas of adjacent heating plate strips and are welded or soldered to each other. Lining plates 48 each have a thickness which corresponds to the amplitude of the scalloping of scalloped heating plate strips 45.

The scalloping of heating plate strips 45 forms a honeycomb structure which provides a large inflow surface for the gas stream flowing through heating device 34.

In an alternative embodiment, several lining plates can be disposed between adjacent heating plate strips. It is also conceivable for the spacer structure to be realized as a comb structure in which the end areas of the heating plate strips are inserted.

Furthermore, reference is made to the aspect that only scalloped heating plate strips are provided in the heating plate stacks in the variation shown in FIGS. 9 to 12, these scalloped heating plate strips each being connected to each other in their two end areas via a conductive spacer structure made of lining plates or the like.

It is generally conceivable that the heating devices of the heating units have different constructional heights and/or different honeycomb channel shapes in different layers 27 of heating assembly 20. Heating devices 34 of a layer 27 of heating assembly 20 are switched in series via contact plates 49 in the embodiment at hand. It is certainly also conceivable for heating devices 34 to be switched parallel. Furthermore in the embodiment at hand, consecutive layers are switched parallel in pairs via contact strips 50. Generally, heating devices 34 can be wired in any manner as required.

In order to be able to determine the temperature of the gas stream heated by means of heating assembly 20, a thermal element 51 is disposed in cover 29 in a transverse bore of a molded brick 30.

In FIGS. 13 to 17, a heat storage device 60 is shown which mostly corresponds to the heat storage device in FIGS. 1 to 3, except in the respect that it does not comprise a stack heater of the type described above in heating space 16, which forms a heating channel. Indeed, resistance heating elements 61 engage in heating space 16, heating elements 61 being made of heating coils or the like and being connected to a power grid via a connection area 62. In all other respects, heat storage device 60 corresponds to the heat storage device in FIGS. 1 to 3, for which reason reference is made to the description thereof

According to heat storage device 1 and 1′, heat storage device 60 can be switched in a loading operation by means of corresponding valves, a gas stream consisting of hot air being introduced via a loading opening 7 during the loading operation. As can be seen in FIG. 13, this gas stream is introduced into heating space 16 from the top and heated by means of resistance heating elements 61 and guided through heat storage means 17, which is built of molded bricks 19, via gas distribution space 24, which forms an open volume. Molded bricks 19 are loaded, i.e., heated, in this manner. The then cooled gas stream is dissipated from heat storage device 60 via gas distribution space 25 and inlet/outlet opening 8.

During an unloading operation shown in FIG. 14, a gas stream consisting of hot air is introduced into the heat storage device via inlet/outlet opening 8 and guided through and heated in heat storage means 17, which is formed by molded bricks 19, from the bottom to the top via gas distribution space 25. After the gas stream has been heated, it is dissipated from the heat storage device via upper gas distribution space 24 and unloading opening 9 for further use.

In FIG. 15, a heating operation without heat storage is shown for heat storage device 60. During this operation, a hot-air gas stream is introduced into the heat storage device via loading opening 7 and heated in heating space 16 by means of resistance heating elements 61 and then dissipated from heat storage device 60 as a hot-air gas stream via upper gas distribution space 24 and unloading opening 9.

According to FIG. 16, described heat storage device 60 can be operated in such a manner that a hot-air gas stream can be introduced into the heat storage device via loading opening 7 and be heated by means of resistance heating element 61. The resulting hot-air gas stream is divvied up in upper gas distribution space 24 and on the one hand dissipated from heat storage device 60 via unloading opening 9 and on the other hand guided through there for loading heat storage means 17, which is made of molded bricks 19, and subsequently dissipated from the heat storage device via lower gas distribution space 25 and inlet/outlet opening 8.

During another operating mode shown in FIG. 17, heat storage device 60 can be operated in such a manner that a hot-air gas stream is introduced via loading opening 7 and inlet/outlet opening 8 in each instance. The gas stream introduced via loading opening 7 is guided in heating space 16 upward in the vertical direction and heated by means of resistance heating element 61 and dissipated via upper gas distribution space 24 and unloading opening 9. The hot-air gas stream introduced via inlet/outlet opening 8 is guided through loaded heat storage means 17 and heated there via heat exchange in order to also be dissipated from the heat storage device via upper gas distribution space 24 and unloading opening 9 subsequently.

The described operational modes can certainly also be realized by means of the heat storage devices in FIGS. 1 to 6.

In FIGS. 18 to 20, a heat storage system 70 is shown which has a heat storage device 71 which is realized either according to the embodiments shown in FIGS. 1 to 6 or according to embodiment shown in FIGS. 12 to 17. Moreover, heat storage system 70 comprises a pipe assembly 72, which is connected to a consumer 73 realized as, for example, a steam generator of a power plant. Pipe assembly 72 comprises a pipe 74 which connects unloading opening 9 of heat storage device 71 to an inlet 75 of consumer 73. Loading opening 7 of heat storage device 71 is connected to a pipe 76 of pipe assembly 72, and inlet/outlet opening 8 of heat storage device 72 is connected to a pipe 77 of pipe assembly 72. An outlet 78 of consumer 73 is connected to a pipe 79, which leads to a fan 80 which in turn is connected to loading opening 7 of heat storage device 71 via pipe 76. Downstream of fan 80, a pipe branch 81 branches from pipe 76, pipe branch 81 being connected to pipe 77. Upstream of fan 80, a pipe branch 82 branches from pipe 76, pipe branch 82 also being connected to pipe 77.

In order to be able to switch heat storage system 70 in different operational modes, a valve 83 is disposed in pipe 76; a valve 84 is disposed in pipe branch 81; a valve 85 is disposed in pipe branch 82; and a valve 86 is disposed in pipe 79 upstream of the branching of pipe branch 82. Instead of the valves or in addition to them, other suitable locking armatures, such as claps or the like, can be used.

Furthermore, heat storage device 71 is connected to a power source 87 which can be realized by the power grid or a photovoltaic system or a wind power plant and is provided with a switch 88. During a loading operation, during which electric energy is converted to heat and the heat is to be stored in heat storage means 17 of heat storage device 71, a hot-air gas stream is introduced from below into heating space 16 of heat storage device 71 via loading opening 7 by means of fan 80 when valve 83 is open. Switch 88 is closed, meaning the heating assembly is in operation and the gas stream is heated in heating space 16. The heated gas stream is guided into storage space 15 via upper gas distribution space 24 and guided from the top downward through the heat storage bed formed by heat storage means 17, the heat being emitted thereto and stored there. Subsequently, a hot-air gas stream is dissipated from heat storage device 71 via inlet/outlet opening 8 and guided to fan 80 via pipe 77 and pipe branch 82 in order to be able to be supplied to heat storage device 71 in the manner described above. Valves 84 and 86 are closed during this loading mode.

During an unloading mode shown in FIG. 19, valves 84 and 86 are open and valves 83 and 85 are closed. By means of fan 80, hot air is introduced into heat storage device 71 via pipe branch 81 and pipe 77 and inlet/outlet opening 8 and is heated in the storage bed formed by heat storage means 17. The yielded hot-air gas stream is dissipated from heat storage device 71 from the top via unloading opening 9 and made available to consumer 73 via pipe 74. This in turn emits hot air which can be supplied to heat storage device 71 by means of fan 80 in the manner described above.

During a mere heating operation shown in FIG. 20, valves 84 and 85 are closed, whereas valves 83 and 86 are open. By means of fan 80, hot air can be introduced into and heated in heating space 16 of heat storage device 71. The resulting hot-air gas stream is guided out of heat storage device 71 via unloading opening 9 and then supplied to consumer 73 via pipe 74. Consumer 73 in turn emits a hot-air gas stream which is guided to fan 80 via pipe 79 and can be guided to heat storage device 71 in the manner described above.

An embodiment of a heat storage system which is not shown can be realized as a partially open system in which the air exiting the consumer can be entirely or partially emitted to the environment. On the suction side of the fan, ambient air is suctioned in corresponding amounts when unloading the heat storage device. In all other respects, this embodiment corresponds to the embodiment described above.

### REFERENCE NUMERALS

1, 1′ heat storage device
2 container
3 interior
4 container top
5 container bottom
6 lateral walls
7 loading opening
8 inlet/outlet opening
9 unloading opening
10 servicing opening
11 wall element
12 insulation layer
13, 13′ partition
14 grid structure
15 storage space
16 heating space
17 heat storage means
18 molded bricks
19 molded bricks
20 heat assembly
21 connections
22 feet
23 ledge
24 gas distribution space
25 gas distribution space
26 molded brick
27 layers
28 heating unit
29 cover
30 molded bricks
31 connection contact
32 connection contact
33 mounting element
34 heating device
35 bottom plate
36 lateral walls
37 recess
38 seal
39A, B, C, D, E, F heating plate unit
40 contact plate
41 partition
42 lateral wall
43 connector
44 connector
45 heating plate strip
46 heating plate strip
47 spacer structure
48 lining plate
49 contact plate
50 contact strip
51 thermal element
60 heat storage device
61 resistance heating elements
62 connection area
70 heat storage system
71 heat storage device
72 pipe assembly
73 consumer
74 pipe
75 inlet
76 pipe
77 pipe
78 outlet
79 pipe
80 fan
81 pipe branch
82 pipe branch
83 valve
84 valve
85 valve
86 valve
87 power source
88 switch
261 perforated plate

1. A heating device for heating a gas stream, the heating device comprising two electric connection elements for being connected to a power source and at least one heating plate unit having an inlet side and an outlet side, which comprises a plurality of heating plate strips which are in the gas stream and each have a first end area and a second end area, adjacent heating plate strips being connected to each other in the first end areas and the second end areas each via a conductive spacer structure.

2. The heating device according to claim 1, wherein the heating plate strips of the heating plate unit alternate between being structured and flat.

3. The heating device according to claim 2, wherein the structured heating plate strips have a scalloping and are supported on at least one adjacent flat heating plate strip by their wave peaks.

4. The heating device according to claim 1, characterized in that wherein the conductive spacer structure comprises lining plates, which are disposed between adjacent heating plate strips and connect these with each other, and/or a comb structure, which receives the heating plate strips.

5. The heating device according to claim 3, wherein the conductive spacer structure comprises lining plates, which are disposed between adjacent heating plate strips and connect these with each other, and/or a comb structure, which receives the heating plate strips and wherein the scalloping has an amplitude which corresponds to the thickness of the lining plates.

6. The heating device according to claim 4, wherein the heating plate strips and the lining plates are each welded, soldered and/or riveted together in both end areas.

7. The heating device according to claim 1, characterized by comprising at least two heating plate units, between which an electrically insulating partition is disposed.

8. The heating device according to claim 7, wherein both heating plate units are electrically connected to each other via a contact plate.

9. The heating device according to claim 8, wherein the connecting elements align with the contact plate.

10. A heating system for a gas stream, the heating system comprising an inlet side and an outlet side and a heating arrangement, which comprises the at least one heating unit, which comprises a heating device having an inflow base area, which is perpendicular to the gas stream, and at least one mounting element, on which the heating device is disposed and which is permeable to the gas stream so that the gas stream can flow onto the inflow base area of the heating device or the gas stream can flow from the heating device through the mounting element.

11. The heating system according to claim 10, wherein the mounting element is made of an electrically insulating, heat-resistant, working material.

12. The heating system according to claim 10, wherein the mounting element comprises a molded brick in which the flow channels are formed which lead to the heating device.

13. The heating system according to claim 10, wherein the mounting element has a support surface which corresponds with the inflow base area of the heating device.

14. The heating system according to claim 10, wherein the mounting element is equipped with lateral walls which laterally delimit the heating device and is formed to be gas-tight.

15. The heating system according to claim 14, wherein the lateral walls are made in one piece with the mounting element.

16. The heating system according to claim 10, wherein the heating assembly comprises several heating units, which are adjacent to each other.

17. The heating system according to claim 10, wherein the heating assembly comprises several heating units, which are superjacent.

18. The heating system according to claim 17, wherein the superjacent heating units are secured against a relative displacement by a bearing safety.

19. The heating system according to claim 10, wherein the heating assembly has a cover through which the gas stream can pass and which forms the upper side of the heating assembly.

20. The heating system according to claim 10, wherein the heating assembly is disposed on a carrier structure.

21. The heating system according to claim 20, wherein the carrier structure comprises a grid structure on which the heating assembly rests.

22. The heating system according to claim 20, wherein the carrier structure comprises at least one molded brick and/or a filling.

23. The heating system according to claim 10, wherein the carrier structure comprises at least one gas deflection channel.

24. The heating system according to claim 10, further comprising a heating channel in which the heating assembly is disposed.

25. The heating system according to claim 24, wherein the heating channel has an inner insulation.

26. The heating system according to claim 24, wherein the heating channel is made of a tube or a rectangular flow channel.

27. The heating system according to claim 24, wherein the heating channel has a lateral opening which is closed by a detachable wall element.

28. The heating system according to claim 10, wherein a throttle device and/or a locking device is disposed on the entrance side and/or on the exit side.

29. The heating system according to claim 10, wherein the heating device comprises two electric connection elements for being connected to a power source and the at least one heating plate unit having an inlet side and an outlet side, which comprises a plurality of heating plate strips which are in the gas stream and each have a first end area and a second end area, adjacent heating plate strips being connected to each other in the first end areas and the second end areas each via a conductive spacer structure.

30. A heat storage device, comprising a container having an interior which has a storage space in which a heat storage means for storing thermal energy is disposed, the container comprising a first opening via which a gas stream is introduced into the interior and a second opening (8) via which the gas stream can be dissipated, wherein a heating space in which an electric heating system is disposed through which the gas stream flows, the heating space being connected to the storage space for the heat storage means via an open volume of the interior.

31. The heat storage device according to claim 30, wherein the heating space is disposed in the interior of the container and is separated from the storage space for the heat storage means by a partition.

32. The heat storage device according to claim 30, wherein the heat storage means is disposed on a carrier construction.

33. The heat storage device according to claim 32, wherein the carrier construction comprises a grid structure.

34. The heat storage device according to claim 32, wherein a gas distribution space is disposed below the carrier construction, the gas distribution space being connected to an opening of the container.

35. The heat storage device according to claim 34, wherein the opening is the second opening.

36. The heat storage device according to claim 30, further comprising a discharge opening which is disposed above the heat storage means.

37. The heat storage device according claim 30, wherein the heat storage means comprises molded bricks through which the gas stream can flow.

38. The heat storage device according to claim 30, further comprising a servicing opening which is closed by a detachable wall element.

39. The heat storage device according to claim 30, wherein the heating space has an at least mostly rectangular cross section.

40. The heat storage device according to claim 30, wherein the heating space has an exit opening which is disposed at a level of an upper side of the heat storage means, the open volume of the interior being above the heat storage means.

41. The heat storage device according to claim 30, wherein the heating system comprises a resistance heater.

42. The heat storage device according to claim 30, wherein a gas distribution space is disposed below the heating system and downstream of the first opening.

43. The heat storage device according to claim 30, wherein the heating system comprises an inlet side and an outlet side and a heating arrangement, which comprises the at least one heating unit, which comprises a heating device having an inflow base area, which is perpendicular to the gas stream, and at least one mounting element, on which the heating device is disposed and which is permeable to the gas stream so that the gas stream can flow onto the inflow base area of the heating device or the gas stream can flow from the heating device through the mounting element.

44. A heat storage system, comprising a heat storage device according to claim 30 and a pipe assembly which is connected to the heat storage device.

45. The heat storage system according to claim 44, wherein a pipe of the pipe assembly is connected to each opening of the heat storage device, the pipe assembly forming a functional circuit in which a consumer is disposed and which is realized to be open or closed.

46. The heat storage system according to claim 44, wherein a fan is disposed in the pipe assembly.

47. The heat storage system according to claim 44, wherein the pipe assembly comprises a charging circuit which is connected to two openings of the heat storage device.

48. The heat storage system according to claim 44, wherein the pipe assembly comprises valves for controlling the gas stream via the heat storage device.
